(19) United States
(12) Patent Application Publication
(10) Pub. No.: US 2025/0350044 A1
(43) Pub. Date: Nov. 13, 2025

(54) MECHANICAL WIRE LUG CLAMPING

(71) Applicant: Schneider Electric USA, Inc., Andover, MA (US)

(72) Inventor: José Martín Hernández Ramírez, Andover, MA (US)

(73) Assignee: Schneider Electric USA, Inc., Andover, MA (US)

(21) Appl. No.: 18/656,823

(22) Filed: May 7, 2024

(51) Int. Cl. H01R 4/36; H01R 11/07; H01R 11/12

(52) U.S. Cl. CPC H01R 4/36; H01R 11/07; H01R 11/12

(57) ABSTRACT

A mechanical lug includes a lug body. The lug body defines a wire receptacle bore therethrough along a wire axis from a first face of the lug body to a second face of the lug body opposite the first face. The lug body also defines a WBS bore extending from a third face of the lug body into the wire receptacle bore along a screw axis that is lateral to the wire axis. The wire receptacle bore has a cross-sectional shape relative to the wire axis that includes opposed clamping surfaces that converge toward one another in a direction away from the WBS bore. The clamping surfaces are configured to clamp a wire urged into the opposed clamping surfaces by a WBS in the WBS bore.

### BACKGROUND

### 1. Field

The present disclosure relates to mechanical lugs, and more particularly to mechanical lugs for clamping wires such as electrical wires.

### 2. Description of Related Art

Traditional mechanical lugs clamp a wire in a bore, deforming a standard circular cross-section wire into an oval cross-section, using a wire binding screw (WBS) that is engaged to the lug body. The bore of the lug must bigger that the standard, circular diameter of the wire. This makes it so frequently, especially for smaller wires, the wire is not properly centered under the WBS in the lug.

Different kinds of wires, e.g., solid wires, stranded wires, and concentric wires, have different behaviors in the clamping process. Regardless of the type of wire, generally the smaller the wire, the greater the possibility of a pull-out failure. A pull-out failure is a failure of the lug to hold the wire under reasonable conditions. Smaller diameter wires tend to be the most problematic, since the traditional lugs are designed to work best with the bigger sizes of wires.

Thermal elongation has a negative effect on the ability of a traditional lug to continue to have a suitable grip on a wire during thermal cycling of the lug and wire. A mechanical gap or loosening can be created by thermal elongation of lug body and the WBS. This gap or loosening reduces the preload on the wire, and typically the greater the temperature, the greater is this mechanical gap or loosening.

The traditional lugs have been considered satisfactory for their intended purpose. For instance, the foregoing problems can be mitigated by proper inspection, maintenance, proper selection of lugs and wires for a given application, thermal management, and the like. Nonetheless, there is an ongoing need for improved mechanical lugs for clamping wires. This disclosure provides a solution for this need.

### SUMMARY

A mechanical lug includes a lug body. The lug body defines a wire receptacle bore therethrough along a wire axis from a first face of the lug body to a second face of the lug body opposite the first face. The lug body also defines a wire binding screw (WBS) bore extending from a third face of the lug body into the wire receptacle bore along a screw axis that is lateral to the wire axis. The wire receptacle bore has a cross-sectional shape relative to the wire axis that includes opposed clamping surfaces that converge toward one another in a direction away from the WBS bore. The clamping surfaces are configured to clamp a wire urged into the opposed clamping surfaces by a WBS in the WBS bore.

A cylindrical fillet surface can join the two clamping surfaces. The cross-sectional shape of the wire receptacle bore can be a rectangular shape including a pair of flat surfaces opposed to the clamping surfaces. The rectangular shape can include a respective cylindrical fillet surface at each of four corners of the rectangular shape. Each of the respective cylindrical fillet surfaces can have a radius equal with one another. The rectangular shape can be a rounded square shape with four equal length sides and four equal angle corners. The wire receptacle bore can be configured to accommodate a single strand circular cross-section wire as large in diameter as a span across two opposing sides of the square shape.

The WBS bore can include female threads extending helically about the screw axis. A WBS with male threads can be engaged to the female threads of the WBS bore. The WBS can include an axial end face in the wire receptacle bore. The WBS can be configured to clamp a wire between the axial end face and the clamping surfaces. The axial end face can include a circumferential rim extending around the screw axis surrounding an end pocket defined in the axial end face. The circumferential rim and the end pocket can be configured to deform a section of a wire in the wire receptacle bore so that the circumferential rim presses into the wire and a portion of the wire extends radially outward relative to the rim along the screw axis, into the end pocket to secure the wire in the lug body in case of differential thermal expansion of the WBS and lug body causing the wire to loosen its preloading relative to the lug body and to the WBS. The end pocket can define a conical surface extending inward into the WBS from the circumferential rim along the screw axis.

The wire can be clamped in the wire receptacle bore by the WBS with a portion or section of the wire extending into the end pocket along the screw axis. The wire can be a single strand circular cross-section wire. The wire can be a multiple strand wire. The wire can have a cross-sectional diameter relative to the wire axis that is less than or equal to a span between two parallel opposed surfaces of the wire receptacle bore. The wire can have a cross-sectional radius that is greater than or equal to a cylindrical fillet radius of corners of a cross-sectional shape of the wire receptacle bore relative to the wire axis.

The WBS bore and wire receptacle bore can be a first clamping set defined in the lug body, and at least one additional clamping set can be defined in the lug body with a respective WBS bore and a respective wire receptacle bore. A connection flange can extend from the lug body, with a fastener bore defined through the connection flange configured for fastening the lug body to a housing body.

A screw for a mechanical lug includes a wire binding screw (WBS) body extending along a screw axis with male threads winding helically around the screw axis configured to be engaged to female threads of a WBS bore in a mechanical lug. The WBS body includes an axial end face. The WBS is configured to clamp a wire between the axial end face and clamping surfaces of a mechanical lug. The axial end face includes a circumferential rim extending around the screw axis surrounding an end pocket defined in the axial end face. The circumferential rim and the end pocket are configured to deform a section of a wire in the mechanical lug so that the circumferential rim presses into the wire and a portion of the wire presses into the end pocket to secure the wire in the mechanical lug in case of differential thermal expansion causing loosening of preloading on the wire.

The end pocket can define a conical surface extending inward into the WBS from the axial end face along the screw axis. A driving end of the WBS body opposite the axial end face can define a driver receptacle configured to receive a driver tool for turning the WBS body about the screw axis.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an embodiment of a mechanical lug constructed in accordance with the present disclosure, showing the wire binding screw (WBS) bore and the wire receptacle bore;

FIG. 2 is a front elevation view of the mechanical lug of FIG. 1, showing the cross-sectional shape of the wire receptacle bore;

FIG. 3 is a schematic perspective view of a WBS for the mechanical lug of FIG. 1, showing the rim and pocket in the axial end face;

FIG. 4 is a schematic view of the cross-sectional shape of the wire receptacle bore, showing various dimensional parameters of the cross-sectional shape;

FIG. 5 is a schematic view of the mechanical lug of FIG. 1, showing a wire in the wire receptacle bore that is deformed out of round to span the cross-sectional shape of the wire receptacle bore;

FIG. 6 is a schematic perspective view of the mechanical lug of FIG. 1, showing three single strand wires all seated in the wire receptacle bore;

FIG. 7 is a schematic front elevation view of the mechanical lug of FIG. 6, showing the three wires being clamped;

FIGS. 8A, 8B, and 8C are schematic perspective views of solid, stranded, and concentric stranded wires, respectively, for use with the mechanical lug of FIG. 1;

FIG. 9 is a schematic perspective view of the mechanical lug of FIG. 1, showing the wire in the wire receptacle bore with the WBS clamping the wire;

FIG. 10 is a schematic, cross-sectional side elevation view of the mechanical lug and wire of FIG. 9, schematically showing the portion of the wire in the pocket of the WBS;

FIG. 11 is a schematic perspective view of a configuration of the mechanical lug of FIG. 1, showing a WBS with an Allen wrench receptacle;

FIG. 12 is a schematic perspective view of a configuration of the mechanical lug of FIG. 1, showing a lug body with two WBS bores and two wire receptacle bores;

FIG. 13 is a schematic perspective view of a configuration of the mechanical lug of FIG. 1 that does not have a connection flange;

FIG. 14 is a schematic perspective view of a configuration of the mechanical lug of FIG. 1, showing a lug body with two different sizes of wire receptacle bores and WBS bores; and

FIG. 15 is a schematic perspective view of a configuration of the mechanical lug of FIG. 1, showing multiple wire receptacle bores and WBS bores of different sizes.

### DETAILED DESCRIPTION OF THE PREFERRED EMBODIMENTS

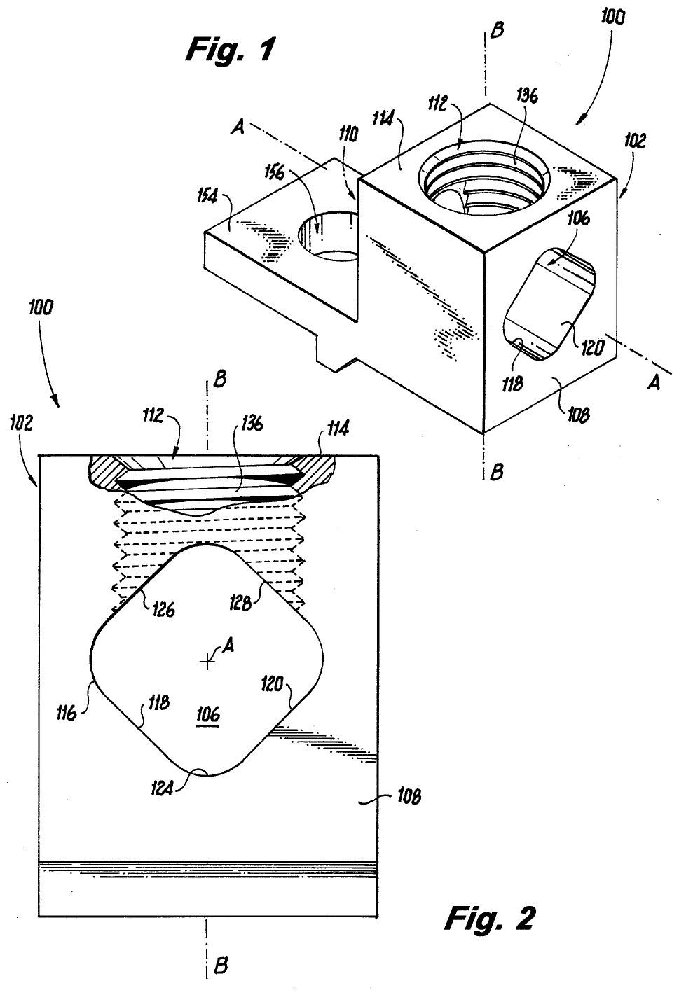

Reference will now be made to the drawings wherein like reference numerals identify similar structural features or aspects of the subject disclosure. For purposes of explanation and illustration, and not limitation, a partial view of an embodiment of a mechanical lug in accordance with the disclosure is shown in FIG. 1 and is designated generally by reference character 100. Other embodiments of systems in accordance with the disclosure, or aspects thereof, are provided in FIGS. 2-15, as will be described. The systems and methods described herein can be used to provide capability for resisting or preventing pull out failures for wires clamped in mechanical lugs.

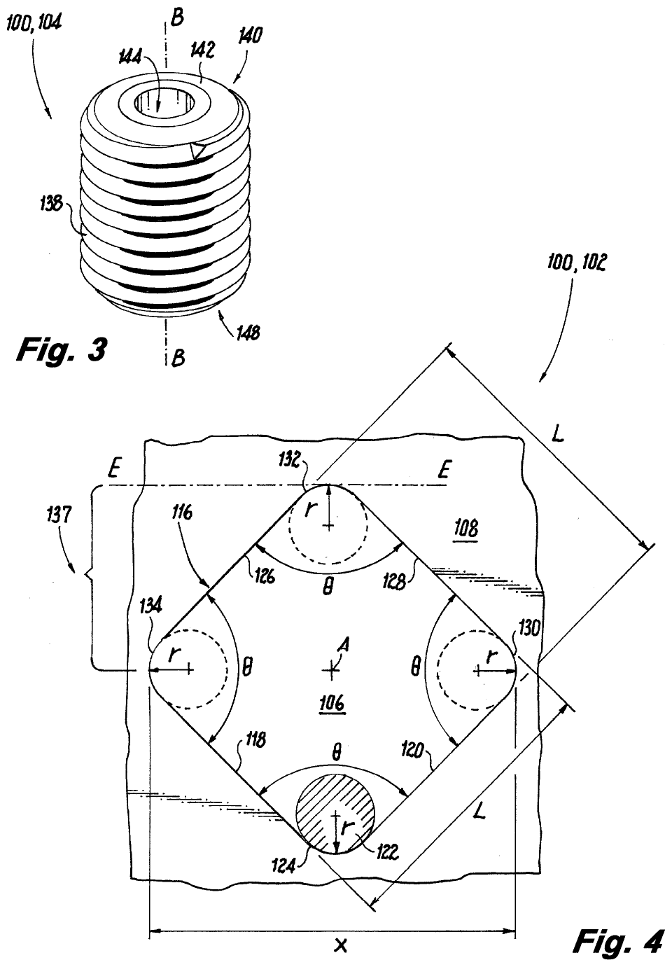

A mechanical lug 100 includes a lug body 102. The mechanical lug 100 also includes a wire binding screw (WBS) 104, shown in FIG. 3. The lug body 102 defines a wire receptacle bore 106 therethrough from a first face 108 of the lug body 102 to a second face 110 of the lug body 102 opposite the first face 108. The wire receptacle bore 106 extends along a wire axis A. The lug body 102 also defines a WBS bore 112 extending from a third face 114 of the lug body 102 into the wire receptacle bore 106 along a screw axis B that is lateral to the wire axis A. The WBS bore 112 does not need to extend through the lug body 102 beyond the wire receptacle bore 106. The wire receptacle bore 106 has a cross-sectional shape 116, shown in FIGS. 2 and 4, relative to the wire axis A that includes opposed planar clamping surfaces 118, 120 that converge toward one another in a direction away from the WBS bore 112, e.g., downward as oriented in FIG. 2. The clamping surfaces 118, 120 form a V-shaped notch in the bottom of the wire receptacle bore 106 as oriented in FIG. 2 and are configured to clamp and automatically center a wire 122 urged into the opposed clamping surfaces 118, 120 by the WBS 104 in the WBS bore 112 as further described below.

With reference now to FIG. 4, the cross-sectional shape 116 of the wire receptacle bore 106 is shown schematically. A cylindrical fillet surface 124 joins the two clamping surfaces 118, 120 to each other. The cross-sectional shape 116 of the wire receptacle bore 106 is a rectangular shape including a pair of flat surfaces 126, 128 opposite from the pair of clamping surfaces 118, 120. The rectangular shape 116 includes a respective cylindrical fillet surface 124, 130, 132, 134 at each of four corners of the rectangular shape 116. The respective cylindrical fillet surfaces 124, 130, 132, 134 each have a radius r equal with one another. The rectangular shape 116 is a rounded square shape with four equal length sides and four equal angle corners, where the angle of the corners is denoted with the character θ in FIG. 4.

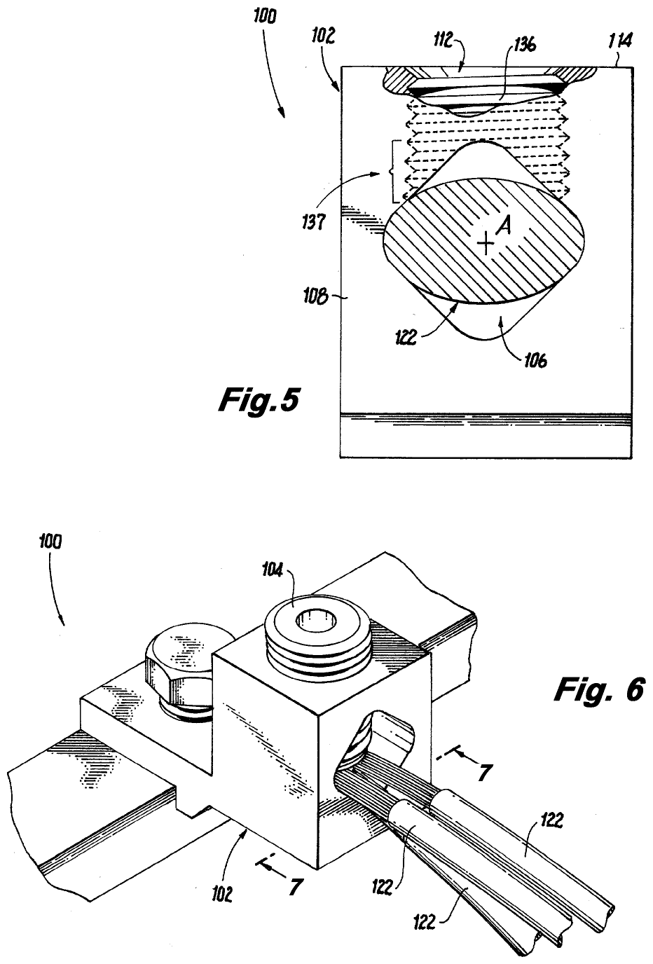

With reference to FIG. 5, the WBS bore 112 includes female threads 136 extending helically about the screw axis B. The upper surfaces 126, 128 of the rectangular cross-sectional shape 116 provide for a longer threading length for the female threads 136, labeled in FIG. 5, in the WBS bore 112, then would a flat ceiling in the cross-sectional shape 116 at the elevation E. This extra threading length, relative to what the threading length would be with a flat ceiling in the cross-sectional shape 116 at the elevation E, is denoted with the reference character 137 in FIGS. 4 and 5.

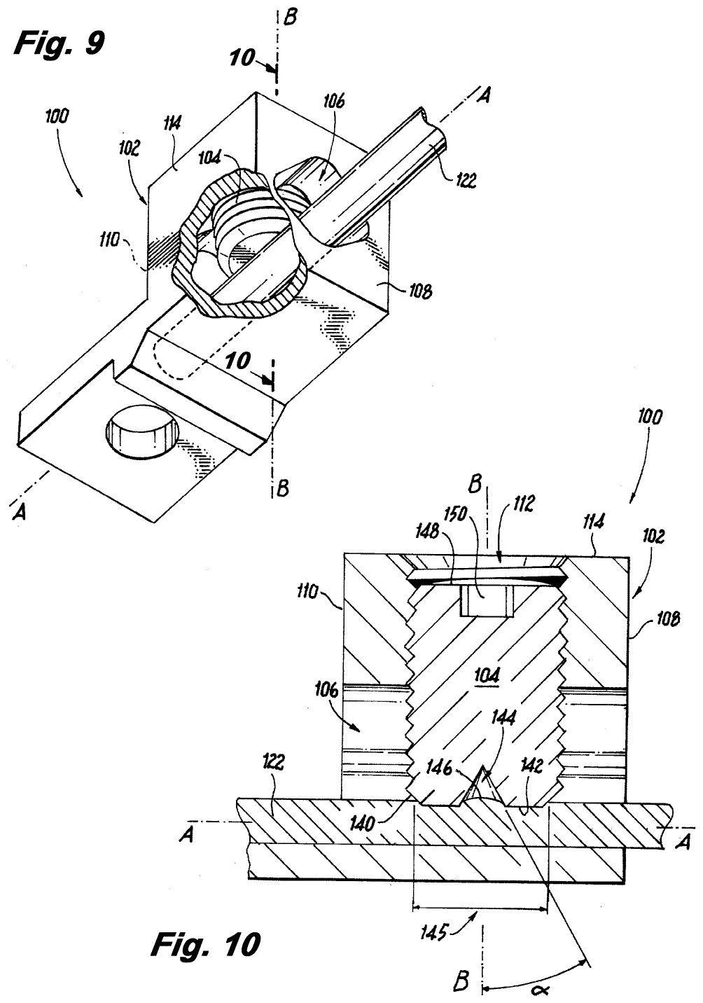

The wire receptacle bore 106 is configured to accommodate a single strand circular cross-section wire as large in diameter as the span L across two opposing sides of the square shape 116. The span L is the span between surfaces 118, 128 which is equal to the span L between surfaces 120, 126. The radius r represents a recommended lower limit for wire radius for a single strand wire 122 of circular cross-section clamped by the mechanical lug 100, to help ensure automatic centering when the WBS 104 clamps the wire 122 in the wire receptacle bore 106 as shown in FIGS. 9-10. The diagonal span X of the square shape 116 is the long dimension of an oval cross-section of a wire 122 deformed from a circular cross-section when clamped in the wire receptacle bore 106 as shown in FIG. 5. The wire 122 prior to clamping has a cross-sectional diameter relative to the wire axis A that is less than or equal to the span L, e.g., wherein the wire 122 has a cross-sectional radius greater than or equal to the cylindrical fillet radius r of the cylindrical fillet surface 124.

The span L and radius r are related to wire size range of the lug 100, which can change depending on the size of the lug 100. The radius r is equal the radius of the smaller wire radius size for the lug 100, and the span L is equal to the larger wire diameter size for the lug 100. If smaller or larger wire sizes need to be accommodated, those skilled in the art will readily appreciate how to adjust the size of the span L or radius r in designing a mechanical lug 100 in accordance with this disclosure.

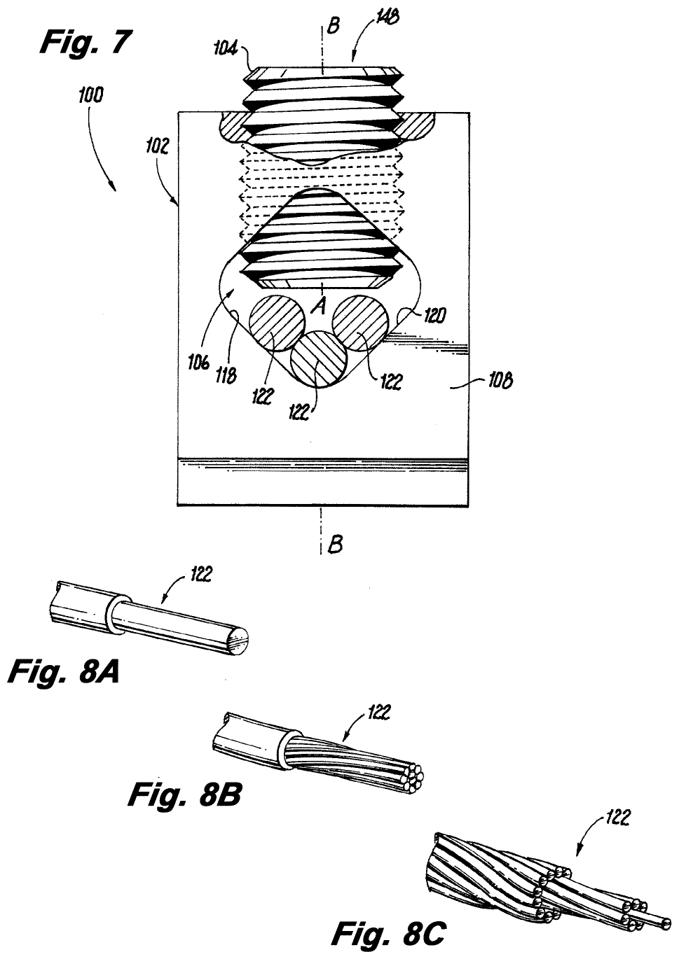

As shown in FIG. 6, multiple wires 122 can be clamped in the mechanical lug 100 at the same time, where the individual wires 122 become automatically centered by the WBS 104 and the clamping surfaces 118, 120 during clamping, as schematically shown in FIG. 7. It is also contemplated that instead of being three separate wires 122 in FIG. 7, the same clamping and centering action would occur in a single wire having three stands, or any suitable number of strands. As shown in FIGS. 8A, 8B, and 8C, the wire 122 can be a solid, single strand wire 122, e.g., of circular cross-section as in FIG. 8A, can be a non-coaxial multi-stranded wire 122 as in FIG. 8B, can be a coaxial multi-stranded wire 122 as in FIG. 8C, or any other suitable type of wire. Note that in FIGS. 4, 5, and 7 the wire axis A is into and out of the viewing plane. This wire axis A is the local longitudinal axis of the wire 122 when seated in the wire receptacle bore 106, as shown in FIG. 9.

With reference now to FIGS. 9-10, a wire 122 can be inserted into the wire receptacle bore 106 with the longitudinal axis of the wire 122 locally aligned with the wire axis A of the lug body 102. The WBS 104 has male threads 138 (labeled in FIG. 3) that engage the female threads 136 of the WBS bore 112 as shown in FIG. 10 so that driving the WBS 104 around the screw axis B can advance the WBS 104 into clamping contact with the wire 122. The WBS 104 includes an axial end face 140 in the wire receptacle bore 106 when the WBS 104 is clamping the wire 122. The WBS 104 is configured to clamp the wire 122 between the axial end face 140 and the clamping surfaces 118, 120 (labeled in FIG. 2), including possible contact with the cylindrical fillet surface 124 conjoining the clamping surfaces 118, 120 to one another, depending on the size of the wire 122. The axial end face 140 includes a circumferential rim 142 extending around the screw axis B surrounding an end pocket 144 defined in the axial end face 140. The circumferential rim 142 and the end pocket 144 are configured to deform a section 145 of the wire 122 in the wire receptacle bore 106 so that the circumferential rim 142 presses into the wire 122 and a portion 146 of the wire 122 extends radially outward relative to the circumferential rim 142 along the screw axis B. The portion 146 of the wire 122 extends radially outward from the wire axis A along the screw axis B into the end pocket 144 to secure the wire 122 in the lug body 102. This can allow the mechanical lug 100 to retain the wire 122 in place, including passing a pull-out test, even in the event of differential thermal expansion of the WBS 104 and lug body 102 causing the wire 122 to loosen its preloading relative to the lug body 102 and to the WBS 104. The end pocket 144 defines a conical surface extending inward into the WBS 104 from the circumferential rim 142 along the screw axis B. This conical surface can define a 45° cone angle α, labeled in FIG. 3, or any other suitable cone angle. A driving end 148 of the body of the WBS 104 opposite the axial end face 140 defines a driver receptacle 150 configured to receive a driver tool for turning the body of the WBS 104 about the screw axis B to advance or withdraw the WBS 104 within the WBS bore 112.

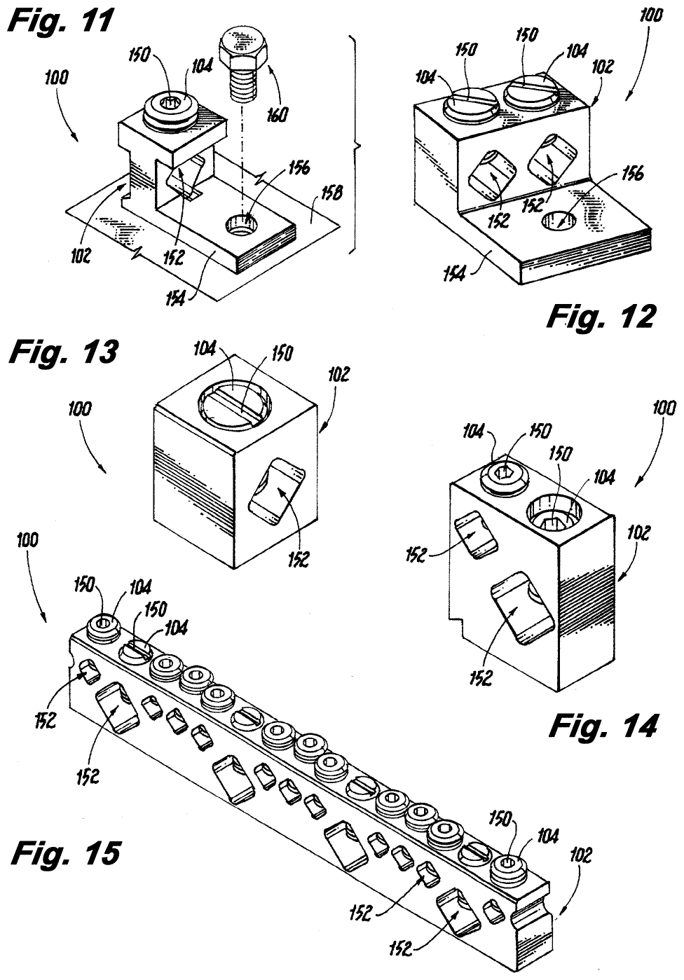

With reference now to FIGS. 11-15, the driver receptacle 150 can be configured for a standard screwdriver as shown in FIGS. 12-13, for a Phillips screwdriver as shown in FIG. 15, for an Allen wrench driver as shown in FIGS. 11 and 14, or for any other suitable type of driver. In FIGS. 11 and 13 (as well as in FIGS. 1-10), the wire receptacle bore 106 and WBS bore 112 are a clamping set 152 defined in the lug body 102, which is the only clamping set of the lug body 102. However, it is also contemplated that at least one additional clamping set 152 can be defined in the lug body 102, as shown in FIGS. 12 and 14-15, each clamping set 152 having its own respective wire receptacle bore 106 and respective WBS bore 112, not all of which are labeled in FIGS. 12 and 14-15 for sake of clarity, but see, e.g., FIG. 1 where the bores 106, 112 are labeled. As shown in FIGS. 11-12, a connection tang or flange 154 extends from the lug body 102, with a fastener bore 156 defined through the connection flange 154 configured for fastening the lug body 102 to a housing body 158 with a fastener 160. It is also contemplated that the connection flange 154 can optionally be omitted, as shown in FIGS. 13-15.

Systems and methods as disclosed herein can provide potential benefits including the following. They can provide for larger wire sizes to be securely clamped in mechanical lugs and can accommodate the deformation of the larger wires in the lug, while also providing secure clamping for smaller wire sizes. The geometry disclosed herein works as an installation poke yoke to fix smaller wire sizes and a suitable range of wire sizes into the center of the lug. The pocket in the end face of the WBS as disclosed herein allows for maintaining a wire securely clamped in the lug even during thermal cycling that would otherwise loosen the preloading on the wire. Different kinds of wires including solid, non-concentric stranded, and concentric stranded, are all forced to keep to the center of the lug to receive all of the clamping force. Multiple wires in a single wire bore can receive the same compression. The geometry disclosed herein can also increase the quantity of screw threads in contact with lug thread, improving the torque keeping ability of the WBS and increasing material contact for thermal dissipation.

The methods and systems of the present disclosure, as described above and shown in the drawings, provide for clamping wires in a manner configured to resist or prevent pull out failures. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A mechanical lug comprising:
a lug body defining:
a wire receptacle bore therethrough along a wire axis from a first face of the lug body to a second face of the lug body opposite the first face, and
a wire binding screw (WBS) bore extending from a third face of the lug body into the wire receptacle bore along a screw axis that is lateral to the wire axis,
wherein the wire receptacle bore has a cross-sectional shape relative to the wire axis that includes opposed clamping surfaces that converge toward one another in a direction away from the WBS, wherein the clamping surfaces are configured to clamp a wire urged into the opposed clamping surfaces by a WBS in the WBS bore.

2. The mechanical lug as recited in claim 1, wherein a cylindrical fillet surface joins the two clamping surfaces.

3. The mechanical lug as recited in claim 1, wherein the cross-sectional shape of the wire receptacle bore is a rectangular shape including a pair of flat surfaces opposed to the clamping surfaces.

4. The mechanical lug as recited in claim 3, wherein the rectangular shape includes a respective cylindrical fillet surface at each of four corners of the rectangular shape.

5. The mechanical lug as recited in claim 4, each of the respective cylindrical fillet surfaces have a radius equal with one another.

6. The mechanical lug as recited in claim 5, wherein the rectangular shape is a rounded square shape with four equal length sides and four equal angle corners, wherein the wire receptacle bore is configured to accommodate a single strand circular cross-section wire as large in diameter as a span across two opposing sides of the square shape.

7. The mechanical lug as recited in claim 1, wherein the WBS bore includes female threads extending helically about the screw axis.

8. The mechanical lug as recited in claim 7, further comprising a WBS with male threads engaged to the female threads of the WBS bore.

9. The mechanical lug as recited in claim 8, wherein the WBS includes an axial end face in the wire receptacle bore, wherein the WBS is configured to clamp a wire between the axial end face and the clamping surfaces.

10. The mechanical lug as recited in claim 9, wherein the axial end face includes a circumferential rim extending around the screw axis surrounding an end pocket defined in the axial end face, wherein the circumferential rim and the end pocket are configured to deform a section of a wire in the wire receptacle bore so that the circumferential rim presses into the wire and a portion of the wire extends radially outward relative to the rim along the screw axis, into the end pocket to secure the wire in the lug body in case of differential thermal expansion causing the wire to loosen preloading relative to the lug body and to the WBS.

11. The mechanical lug as recited in claim 10, wherein the end pocket defines a conical surface extending inward into the WBS from the circumferential rim along the screw axis.

12. The mechanical lug as recited in claim 10, further comprising the wire clamped in the wire receptacle bore by the WBS with a section of the wire extending into the end pocket along the screw axis.

13. The mechanical lug as recited in claim 12, wherein the wire is a single strand circular cross-section wire.

14. The mechanical lug as recite in claim 12, wherein the wire is a multiple strand wire.

15. The mechanical lug as recited in claim 12, wherein the wire has a cross-sectional diameter relative to the wire axis that is less than or equal to a span between two parallel opposed surfaces of the wire receptacle bore, and has a radius greater than or equal to a cylindrical fillet radius of corners of a cross-sectional shape of the wire receptacle bore relative to the wire axis.

16. The mechanical lug as recite in claim 1, wherein the wire receptacle bore and the WBS bore are a first clamping set defined in the lug body, and further comprising at least one additional clamping set defined in the lug body with a respective wire receptacle bore and a respective WBS bore.

17. The mechanical lug as recite in claim 1, further comprising a connection flange extending from the lug body, with a fastener bore defined through the connection flange configured for fastening the lug body to a housing body.

18. A screw for a mechanical lug comprising:
a WBS body extending along a screw axis with male threads winding helically around the screw axis configured to be engaged to female threads of a WBS bore in a mechanical lug, wherein the WBS body includes an axial end face, wherein the WBS is configured to clamp a wire between the axial end face and clamping surfaces of a mechanical lug, wherein the axial end face includes a circumferential rim extending around the screw axis surrounding an end pocket defined in the axial end face, wherein the circumferential rim and the end pocket are configured to deform a section of a wire in the mechanical lug so that the circumferential rim presses into the wire and a portion of the wire presses into the end pocket to secure the wire in the mechanical lug in case of differential thermal expansion causing loosening of preloading on the wire.

19. The screw as recited in claim 18, wherein the end pocket defines a conical surface extending inward into the WBS body from the axial end face along the screw axis.

20. The screw as recited in claim 18, wherein a driving end of the WBS body opposite the axial end face defines a driver receptacle configured to receive a driver tool for turning the WBS body about the screw axis.
